(19) United States
(12) Patent Application Publication
(10) Pub. No.: US 2014/0085030 A1
(43) Pub. Date: Mar. 27, 2014

(54) TRANSFORMER

(71) Applicant: DELTA ELECTRONICS, INC., Taoyuan Hsien (TW)

(72) Inventors: Yu-Chin Lin, Taoyuan Hsien (TW); Yu-Jen Huang, Taoyuan Hsien (TW); Shao-Dong Zhang, Wujiang City (CN); Cheng-Chang Tsai, Taoyuan Hsien (TW)

(73) Assignee: DELTA ELECTRONICS, INC., Taoyuan Hsien (TW)

(21) Appl. No.: 13/779,494

(22) Filed: Feb. 27, 2013

(30) Foreign Application Priority Data
Sep. 25, 2012 (CN) 201210361519.3

(51) Int. Cl. H01F 27/26

(52) U.S. Cl. CPC H01F 27/263
USPC 336/175

(57) ABSTRACT

A transformer includes a bobbin, a magnetic core assembly, and a hollow pad. The bobbin includes a main body and a channel. The channel runs through the main body. The magnetic core assembly includes a first magnetic part and a second magnetic part. Each of the first magnetic part and the second magnetic part includes a middle post. The middle post is partially inserted into the channel. The hollow pad is arranged between the middle post of the first magnetic part and the middle post of the second magnetic part. The hollow pad has an opening for accommodating a gluing material. The first magnetic part and the second magnetic part are combined together through the gluing material.

### FIELD OF THE INVENTION

The present invention relates to a transformer, and more particularly to a transformer with a hollow pad.

### BACKGROUND OF THE INVENTION

A transformer is a magnetic device that transfers electric energy or magnetic from one circuit to another circuit through coils in order to regulate the voltage to a desired range required for powering an electronic device.

Conventionally, the transformer comprises a bobbin, a magnetic core assembly, a primary winding coil, and a secondary winding coil. The magnetic core assembly comprises two magnetic parts. Each of the tow magnetic parts comprises a middle post and two lateral legs. The two lateral legs are located at bilateral sides of the middle post, respectively. For assembling the magnetic core assembly, a gluing material is firstly coated on the middle post of one of the two magnetic parts, and then the two magnetic parts are fixed on each other through the gluing material. As known, during operations of the transformer, the magnetic core assembly and the winding coils are readily suffered from magnetic vibration. Moreover, during the intermittent operations of the transformer, if the vibration frequency is close to the natural frequencies of the magnetic core assembly and the winding coils, a resonance phenomenon occurs between the magnetic core assembly and the winding coils. Due to the resonance phenomenon, undesired noise is generated. For reducing the noise, the gluing material between the middle posts of the two magnetic parts is helpful to provide a buffering efficacy in order to inhibit the noise.

Generally, the gluing material is made of a thermosetting material. After the gluing material is subjected to a baking process, the two magnetic parts are adhered to each other through the gluing material. However, after the gluing material is baked, the volume of the gluing material is expanded to result in stress. Due to the stress, the middle posts of the two magnetic parts are readily suffered from fracture, or even the magnetic core assembly is damaged. For reducing the influence of the stress from the expanded gluing material, a cushion sheet may be additionally arranged between the two magnetic parts of the magnetic core assembly. Although the cushion sheet is able to reduce the possibility of causing damage of the middle posts of the two magnetic parts, the use of cushion sheet is detrimental to the secure connection between the two magnetic parts. In other words, the noise generated from magnetic vibration fails to be effectively reduced by the cushion sheet.

Therefore, there is a need of providing an improved transformer in order to eliminate the above drawbacks.

### SUMMARY OF THE INVENTION

The present invention provides a transformer, in which the structural strength of the magnetic core assembly is enhanced and the noise from magnetic vibration is reduced.

In accordance with an aspect of the present invention, there is provided a transformer. The transformer is installed on a system circuit board. The transformer includes a bobbin, a magnetic core assembly, and a hollow pad. The bobbin includes a main body and a channel. The channel runs through the main body. The magnetic core assembly includes a first magnetic part and a second magnetic part. Each of the first magnetic part and the second magnetic part includes a middle post. The middle post is partially inserted into the channel. The hollow pad is arranged between the middle post of the first magnetic part and the middle post of the second magnetic part. The hollow pad has an opening for accommodating a gluing material. The first magnetic part and the second magnetic part are combined together through the gluing material.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a transformer according to an embodiment of the present invention;

FIG. 2A is a schematic cross-sectional view illustrating the magnetic core assembly of the transformer according to the embodiment of the present invention, in which the first magnetic part and the second magnetic part are separated from each other; and

FIG. 2B is a schematic cross-sectional view illustrating the magnetic core assembly of the transformer according to the embodiment of the present invention, in which the first magnetic part and the second magnetic part are combined together.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

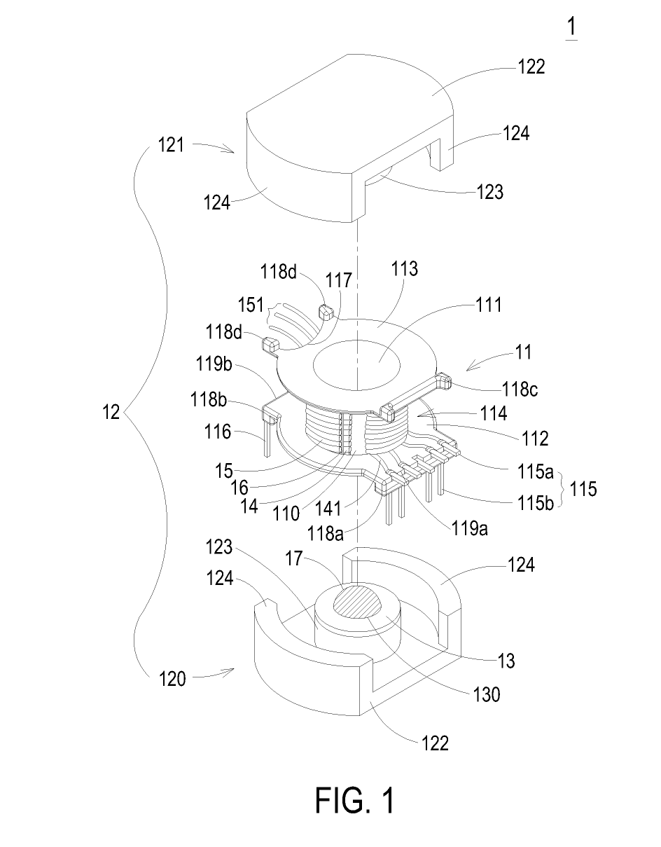

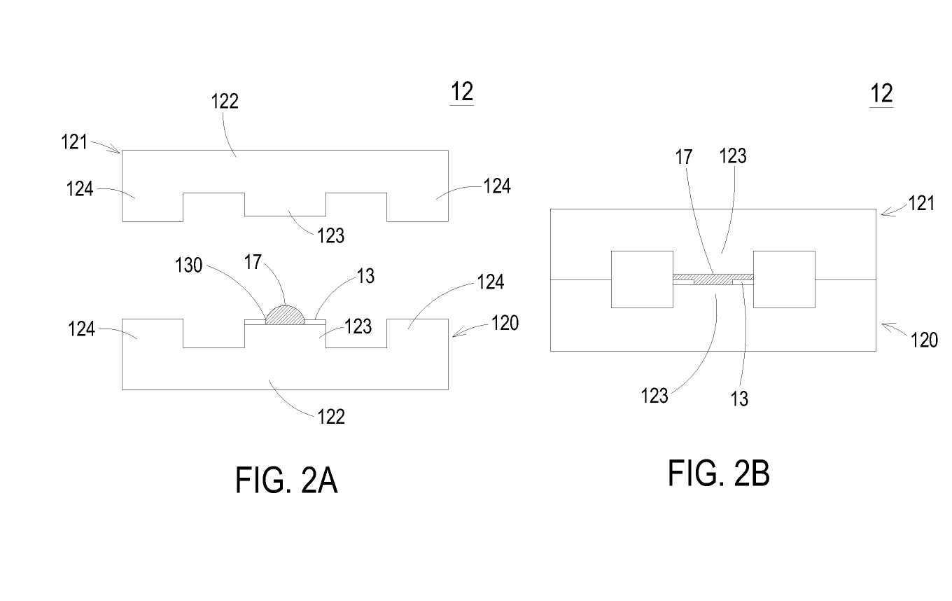

FIG. 1 is a schematic exploded view illustrating a transformer according to an embodiment of the present invention. As shown in FIG. 1, the transformer 1 comprises a bobbin 11, a magnetic core assembly 12, and a hollow pad 13. The bobbin 11 comprises a main body 110 and a channel 111. The channel 111 runs through the main body 110. The magnetic core assembly 12 comprises a first magnetic part 120 and a second magnetic part 121. Each of the first magnetic part 120 and the second magnetic part 121 comprises a middle post 123 and two lateral legs 124. The middle posts 123 are partially inserted into the channel 111 of the bobbin 11. The hollow pad 13 is arranged between the middle post 123 of the first magnetic part 120 and the middle post 123 of the second magnetic part 121. The hollow pad 13 has an opening 130 for accommodating a gluing material 17 (see also FIG. 2A). Through the gluing material 17, the first magnetic part 120 and the second magnetic part 121 are combined together. The detailed structure of the transformer 1 will be illustrated as follows.

Please refer to FIG. 1 again. The transformer 1 further comprises a primary winding coil 14 and a secondary winding coil 15. The primary winding coil 14 and the secondary winding coil 15 are wound around the bobbin 11. Moreover, the bobbin 11 further comprises a first stopping plate 112 and a second stopping plate 113. The main body 110 has a cylindrical shape, but is not limited thereto. The channel 111 runs through the main body 110 along the axial direction of the main body 110. Consequently, the main body 110 is substantially a hollow cylinder. The channel 111 of the bobbin 11 is used for accommodating a part of the magnetic core assembly 12. The first stopping plate 112 and the second stopping plate 113 are perpendicular to the main body 110. Moreover, the first stopping plate 112 and the second stopping plate 113 are located at two opposed sides of the main body 110, respectively. The area of each of the first stopping plate 112 and the second stopping plate 113 is larger than the cross-section area of the main body 110 along the direction perpendicular to the axial direction of the main body 110. In this embodiment, the main body 110, the first stopping plate 112 and the second stopping plate 113 are made of plastic material and integrally formed with each other. Consequently, a winding section 114 is defined by the main body 110, the first stopping plate 112 and the second stopping plate 113 collaboratively. The primary winding coil 14 and the secondary winding coil 15 are wound around the winding section 114.

In this embodiment, the primary winding coil 14 and the secondary winding coil 15 wound around the winding section 114 are enameled wires. The enameled wires are conductive wires that are covered with insulation coverings. Moreover, the primary winding coil 14 and the secondary winding coil 15 are isolated from each other by an insulation medium 16 (e.g. an insulation tape). The primary winding coil 14 has at least one first outlet terminal 141. The secondary winding coil 15 has at least one second outlet terminal 151. The first outlet terminal 141 and the second outlet terminal 151 may be extended from opposite sides of the bobbin 11. The numbers of the first outlet terminal 141 and the second outlet terminal 151 may be varied according to the practical requirements. For clearly illustrating the relationship between the primary winding coil 14, the secondary winding coil 15 and the bobbin 11 of the transformer 1 as shown in FIG. 1, a part of the primary winding coil 14 and a part of the secondary winding coil 15 are cut away. It is noted that the primary winding coil 14 and the secondary winding coil 15 are continuously wound around the winding section 114.

Please refer to FIG. 1 again. The first stopping plate 112 of the bobbin 11 comprises at least one first pin 115 and at least one second pin 116. The at least one first pin 115 is located at a first rim of the first stopping plate 112. The at least one second pin 116 is located at a second rim of the first stopping plate 112. That is, the at least one first pin 115 and the at least one second pin 116 are opposed to each other. Moreover, the at least one first pin 115 and the at least one second pin 116 are inserted into, partially buried within and perpendicular to the bottom of the first stopping plate 112. After the at least one first pin 115 and the at least one second pin 116 are inserted into corresponding conduction holes of a system circuit board (not shown), the transformer 1 may be mounted on the system circuit board. In this embodiment, the first pin 115 has an L-shaped structure, which is partially buried within the first rim of the first stopping plate 112. In this embodiment, the first pin 115 comprises a connecting part 115a and an insertion part 115b. The connecting part 115a and the insertion part 115b are perpendicular to each other. The connecting part 115a is partially buried within the first rim of the first stopping plate 112, and extended from the bottom of the first stopping plate 112 to be inserted into the system circuit board. The connecting part 115a is also partially buried within the first rim of the first stopping plate 112, and horizontally extended from the first stopping plate 112. The first outlet terminal 141 of the primary winding coil 14 is wound around and fixed on the connecting part 115a of the first pin 115. Moreover, the number of the first pin 115 may be varied according to the number of the first outlet terminal 141 of the primary winding coil 14.

In this embodiment, a notch 117 is located at a rim of the second stopping plate 113 of the bobbin 11. The notch 117 is a concave structure formed in the rim of the second stopping plate 113. In this embodiment, the notch 117 and the at least one second pin 116 of the first stopping plate 112 are located at the same side of the bobbin 11 for limiting the position of the second outlet terminal 151 of the secondary winding coil 15. Consequently, the procedure of assembling the bobbin 11 and the magnetic core assembly 12 is not hindered by the second outlet terminal 151.

Moreover, the first stopping plate 112 of the bobbin 11 further comprises a first positioning part 118a and a second positioning part 118b, and the second stopping plate 113 further comprises a third positioning part 118c and a fourth positioning part 118d. The first positioning part 118a and the second positioning part 118b of the first stopping plate 112 are located at a first side 119a and a second side 119b of the first stopping plate 112, respectively. That is, the first positioning part 118a and the second positioning part 118b of the first stopping plate 112 are extended downwardly from the first stopping plate 112. In addition, the third positioning part 118c and the fourth positioning part 118d of the second stopping plate 113 are aligned with the first positioning part 118a and the second positioning part 118b of the first stopping plate 112, respectively. Moreover, the third positioning part 118c and the fourth positioning part 118d are extended upwardly from the second stopping plate 113. Consequently, the first magnetic part 120 of the magnetic core assembly 12 may be positioned by the first positioning part 118a and the second positioning part 118b, and the second magnetic part 121 may be positioned by the third positioning part 118c and the fourth positioning part 118d. During the first magnetic part 120 and the second magnetic part 121 are combined with the bobbin 11, the uses of the positioning parts 118a, 118b, 118c and 118d may facilitate precise placement of the first magnetic part 120 and the second magnetic part 121 on the bobbin 11. The positioning parts 118a, 118b, 118c and 118d may be bulges or slabs. The profiles of the positioning parts 118a, 118b, 118c and 118d are not restricted as long as the positioning parts 118a, 118b, 118c and 118d are protruded from the first stopping plate 112 and the second stopping plate 113 for positioning the magnetic core assembly 12.

FIG. 2A is a schematic cross-sectional view illustrating the magnetic core assembly of the transformer according to the embodiment of the present invention, in which the first magnetic part and the second magnetic part are separated from each other. FIG. 2B is a schematic cross-sectional view illustrating the magnetic core assembly of the transformer according to the embodiment of the present invention, in which the first magnetic part and the second magnetic part are combined together.

Please refer to FIGS. 1, 2A and 2B. The magnetic core assembly 12 of the transformer 1 comprises the first magnetic part 120 and the second magnetic part 121. In this embodiment, the first magnetic part 120 is an E core. The first magnetic part 120 comprises a flat plate 122, the middle post 123 and the two lateral legs 124. The two lateral legs 124 are extended from two opposed edges of the flat plate 122. The middle post 123 is extended from a center of the flat plate 122, and arranged between the two lateral legs 124. Moreover, the shape of the middle post 123 substantially matches the shape of the channel 111 of the bobbin 11. Consequently, when the first magnetic part 120 is combined with the bobbin 11, the middle post 123 of the first magnetic part 120 is accommodated with the channel 111 of the bobbin 11. At the same time, the flat plate 122 of the first magnetic part 120 is attached on the first stopping plate 112, and the movable range of the flat plate 122 is confined by the first positioning part 118a and the second positioning part 118b of the first stopping plate 112. Consequently, the first magnetic part 120 can be positioned on the bobbin 11. Similarly, the second magnetic part 121 is also an E core. The structure of the second magnetic part 121 is substantially identical to the structure of the first magnetic part 120. The relationships between the second magnetic part 121 and the positioning parts 118c and 118d of the second stopping plate 113 of the bobbin 11 are similar to the relationships between the first magnetic part 120 and the positioning parts 118a and 118b of the first stopping plate 112, and are not redundantly described herein.

Please refer to FIGS. 1, 2A and 2B. The opening 130 of the hollow pad 13 runs through a middle region of the hollow pad 13. The gluing material 17 can be precisely accommodated within the opening 130. In this embodiment, the hollow pad 13 is disposed on either the middle post 123 of the first magnetic part 120 or the middle post 123 of the second magnetic part 121. As shown in FIG. 2A, an adhesive (e.g. a single-side adhesive) is formed on a surface of the hollow pad 13, so that the hollow pad 13 is attached on the middle post 123 of the first magnetic part 120 through the adhesive. Then, the gluing material 17 is dispensed into the opening 130 of the hollow pad 13. Consequently, the middle post 123 of the second magnetic part 121 and the middle post 123 of the first magnetic part 120 are fixed on each other through the gluing material 17. Moreover, in this embodiment, the hollow pad 13 is a ring-shaped film. The shape of the periphery of the hollow pad 13 may be varied according to the shape of the periphery of the middle post 123. It is preferred that the shape of the periphery of the hollow pad 13 is identical to the shape of the periphery of the middle post 123. Moreover, the cross section area of the hollow pad 13 is slightly smaller than the cross section area of the middle post 123 of the magnetic core assembly 12. The shape of the periphery of the opening 130 is similar to the shape of the periphery of the hollow pad 13. For example, in a case that the hollow pad 13 is the ring-shaped film with the circular periphery, the opening 130 is a circular opening In a case that the hollow pad 13 has a square periphery, the opening 130 is a rectangular opening It is noted that the shape of the opening 130 may be varied according to the practical requirements. In this embodiment, the magnetic core assembly 12 is an EE-type magnetic core assembly. Alternatively, in some embodiments, the magnetic core assembly 12 is an EI-type magnetic core assembly or any other type magnetic core assembly with a middle post.

Moreover, the gluing material 17 is disposed within the opening 130 of the hollow pad 13 corresponding to the middle post 123 of the first magnetic part 120 by a gluing material-dispensing process. In this embodiment, the gluing material 17 is made of a thermosetting and low-fluidity material such as thermosetting resin. After the bobbin 11 and the magnetic core assembly 12 are combined together, the gluing material 17 between the first magnetic part 120 and the second magnetic part 121 is subjected to a baking process. After the gluing material 17 is solidified, the first magnetic part 120 and the second magnetic part 121 are securely adhered to each other. Moreover, due to the low fluidity of the gluing material 17, the possibility of overflowing the gluing material 17 from the opening 130 of the hollow pad 13 during the gluing material-dispensing process will be minimized. In other words, when the gluing material 17 is dispensed into the opening 130 of the hollow pad 13, the gluing material 17 may be directly contacted with the surface of the middle post 123 of the first magnetic part 120. Consequently, the middle post 123 of the second magnetic part 121 and the middle post 123 of the first magnetic part 120 can be fixed on each other through the gluing material 17 more securely. Under this circumstance, the noise generated from magnetic vibration will be effectively inhibited. Moreover, after the gluing material 17 is baked, the volume of the gluing material 17 is expanded to result in stress. The hollow pad 13 is effective to alleviate the stress of the expanded gluing material 17, thereby preventing damage of the middle posts 123 of the magnetic core assembly 12.

From the above descriptions, the present invention provides a transformer. The transformer comprises a bobbin, a magnetic core assembly, and a hollow pad. The hollow pad has an opening The hollow pad is disposed on the middle post of the first magnetic part or the second magnetic part of the magnetic core assembly. Moreover, the gluing material is disposed within the opening of the hollow pad by a gluing material-dispensing process, so that the middle post is directly contacted with the gluing material through the opening In such way, the middle post of the first magnetic part and the middle post of the second magnetic part can be fixed on each other more securely, and the noise generated from magnetic vibration will be effectively inhibited. After the bobbin and the magnetic core assembly are combined together, the gluing material between the first magnetic part and the second magnetic part is subjected to a baking process. After the gluing material is baked, the volume of the gluing material is expanded to result in stress. The hollow pad is effective to alleviate the stress of the expanded gluing material, thereby preventing damage of the middle posts of the magnetic core assembly. In comparison with the conventional transformer, the transformer of the present invention has many benefits. For example, since the middle post of the first magnetic part and the middle post of the second magnetic part can be fixed on each other more securely through the opening of the hollow pad, the noise is inhibited. Moreover, the hollow pad is effective to alleviate the stress of the expanded gluing material, thereby preventing damage of the middle posts of the magnetic core assembly. In other words, the magnetic core assembly of the transformer of the present invention has reduced noise and enhanced structural strength.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer installed on a system circuit board, said transformer comprising:
a bobbin comprising a main body and a channel, wherein said channel runs through said main body;
a magnetic core assembly comprising a first magnetic part and a second magnetic part, wherein each of said first magnetic part and said second magnetic part comprises a middle post, and said middle post is partially inserted into said channel; and
a hollow pad arranged between said middle post of said first magnetic part and said middle post of said second magnetic part, wherein said hollow pad has an opening for accommodating a gluing material, wherein said first magnetic part and said second magnetic part are combined together through said gluing material.

2. The transformer according to claim 1, wherein said bobbin further comprises a first stopping plate and a second stopping plate, wherein said first stopping plate and said second stopping plate are located at opposed sides of said main body, wherein a winding section is defined by said main body, said first stopping plate and said second stopping plate collaboratively.

3. The transformer according to claim 2, wherein said transformer further comprises a primary winding coil and a secondary winding coil, wherein said primary winding coil has at least one first outlet terminal, and said secondary winding coil has at least one second outlet terminal.

4. The transformer according to claim 3, wherein said first stopping plate comprises at least one first pin and at least one second pin, wherein said at least one first pin is located at a first rim of said first stopping plate, and said at least one second pin is located at a second rim of said first stopping plate, so that said at least one first pin and said at least one second pin are opposed to each other, wherein said at least one first pin and said at least one second pin are inserted into, partially buried within and perpendicular to a bottom of said first stopping plate, so that said at least one first pin and said at least one second pin are mounted on said system circuit board, wherein said at least one first outlet terminal of said primary winding coil is wound around and fixed on said at least one first pin.

5. The transformer according to claim 3, wherein a notch is located at a rim of said second stopping plate of said bobbin, wherein said notch is a concave structure formed in said rim of said second stopping plate for limiting a position of said second outlet terminal of said secondary winding coil.

6. The transformer according to claim 2, wherein said first stopping plate comprises plural positioning parts for positioning said first magnetic part of said magnetic core assembly, and said second stopping plate comprises plural positioning parts for positioning said second magnetic part of said magnetic core assembly.

7. The transformer according to claim 1, wherein each of said first magnetic part and said second magnetic part of said magnetic core assembly comprises a flat plate, said middle post and two lateral legs, wherein said middle post and said two lateral legs are extended from said flat plate.

8. The transformer according to claim 1, wherein said hollow pad is disposed on said middle post of said first magnetic part or said second magnetic part, so that said hollow pad is arranged between said middle post of said first magnetic part and said middle post of said second magnetic part.

9. The transformer according to claim 1, wherein a shape of a periphery of said hollow pad is identical to a shape of said middle post of said first magnetic part or said second magnetic part.

10. The transformer according to claim 1, wherein said gluing material is made of a thermosetting and low-fluidity material.
